(19) United States
(12) Patent Application Publication
(10) Pub. No.: US 2001/0025260 A1
(43) Pub. Date: Sep. 27, 2001

(54) E-commerce periodical subscription service

(76) Inventor: Ari Blumofe, Chicago, IL (US)

Correspondence Address: Thomas E. Hill, Esq., EMRICH & DITHMAR, Suite 3000, 300 South Wacker Drive, Chicago, IL, 60606, US

(21) Appl. No.: 09/788,688

(22) Filed: Feb. 19, 2001

Related U.S. Application Data
(63) Continuation-in-part of application No. 09/519,790, filed on Mar. 7, 2000.

(51) Int. Cl. G06F 17/60

(52) U.S. Cl. 705/27; 705/26

(57) ABSTRACT

Subscriptions to periodicals are arranged for via a communications network, such as the Internet, wireless or cellular links, satellites or a cable/DSL link, using a subscriber terminal. A selected periodical is downloaded via the Internet to the subscriber's terminal with the contents presented on a video display. An authorization code may be assigned to the subscriber terminal, the individual subscriber, or to both, with the code, or codes, verification by an authorizing authority prior to downloading of the requested subscription materials. The terminal is of the interactive type allowing the subscriber to select a specific periodical from a list of available periodicals, perform a word search covering one or more periodicals for a specific subject matter, change the subscription from one to another periodical on a daily, weekly, monthly, etc., basis, or even several times in one day on a real time basis. The subscriber pays a fee to the authorizing authority and receives credit units in accordance with the amount paid or the subscriber's account may be debited. These credit units may be used by the subscriber as desired until the units are used up. Each time a periodical is downloaded to the subscribe's terminal, the subscriber's account is debited. The authorizing authority maintains an account for each subscriber, periodically informing each subscriber of the number of credit units available as well as when the credit units are about to be used up.

### RELATED APPLICATION

This is a continuation-in-part of application Ser. No. 09/519,790, filed Mar. 7, 2000.

### FIELD OF THE INVENTION

This invention relates generally to the distribution of periodical publications and is more particularly directed to an on-line periodical publication order service which allows the subscriber to access and download in real time one or more periodicals for virtually any desired time period, including a single issue.

### BACKGROUND OF THE INVENTION

Most periodical publications such as magazines, newspapers, journals, and newsletters are available to the consumer by subscription. The subscription typically is for a fixed time period and obligates the subscriber to pay for received copies of the publication during this time. Once the original subscription expires, the subscriber must renew the subscription to continue to receive the publication. Once the subscription begins, it is difficult and in some cases impossible to terminate the subscription prior to the scheduled termination date if the subscriber desires to do so. A subscription is typically initiated by a telephone call or written request, with several weeks typically involved between a subscriber's initial request for the publication and delivery of the first issue of the publication under the subscription. There is, therefore, typically a rather extended lead time involved between submission of the subscription request and delivery of the first issue of the publication. In addition, changing a subscription from one publication to another also typically involves a rather extended waiting period. Finally, while the delivery of most periodicals is highly reliable, there is inevitably the missed edition because of a delivery mishap.

The development of global information networks such as the Internet has provided another medium for subscribing to periodical publications. In this type of subscription service, a code is assigned by a subscription authority to a receiving device such as an electronic book used by the subscriber and the requested publication is provided to the designated receiving device following verification of the receiving device's authorizing code by the subscription authority. This approach limits subscriber access to a requested publication for only a designated receiving device, allows others to view the subscription materials on the designated receiving device without authorization, and employs dedicated receiving devices which limit receipt and use of the subscription materials by subscribers.

The present invention addresses the aforementioned limitations of the prior art by providing a periodical subscription service via a global information network such as the Internet, or a communications network employing DSL, satellites, wireless or cellular networks, etc., wherein periodicals are downloaded on a subscriber's remote terminal for viewing, or storage and later viewing, and which allows the subscriber to change the ordered periodical subscriptions or to order additional periodicals on a real time basis. The subscriber registers as a member of the service provided by an authorizing authority, which service continues until changed or terminated by the member. A registration code is assigned by the authorizing authority to either the subscriber or to a device designated by the subscriber, or to both, to prevent unauthorized receipt/use of the subscription materials while allowing for increased flexibility in delivering the materials to an authorized subscriber.

### OBJECTS AND SUMMARY OF THE INVENTION

Accordingly, it is an object of the present invention to assign to a subscriber or to a receiving device designated by the subscriber, or to both, an authorization code for allowing the subscriber to receive one or more selected periodical publications via a global information network, or any other available communications link, with a selected level of transmission security.

Another object of the present invention is to provide greater flexibility for a subscriber in receiving periodical publications via a global information network while maintaining a high level of control over distribution of the subscription materials.

It is another object of the present invention to provide a subscription service using a global information network which permits a subscriber to select from a list of periodicals and to also elect the subscription period, i.e., daily, weekly, monthly, etc.

Yet another object of the present invention is to allow a subscriber to select subscriptions to periodicals on a real time basis, permitting the subscriber to view a periodical, including back issues, immediately after it is selected by receiving, such as by downloading, the periodical at the subscriber's remote terminal.

A further object of the present invention is to assign to a periodical subscriber or to a subscription terminal designated by the subscriber a code word for a computer-based universal subscription account which allows the subscriber, upon payment of the requisite fee such by debiting or charging a credit account, to subscribe to virtually any number of periodicals which are downloaded to the subscriber's remote terminal(s), which may be a desktop computer or a hand held terminal, and to change subscriptions among the various available publications as often as desired, even on a real time daily basis.

A further object of the present invention is to provide a computer-based, interactive subscription service for periodicals which allows subscribers such as in a waiting room, hotel room, hospital room, or other public place to select various periodicals for immediate viewing on a real time basis, such as for example, permitting readers A, B and C to select and view periodicals X, Y and Z, in sequence.

A still further object of the present invention is to provide an electronic magazine in the form of a flat panel display with suitable electronics to permit a periodical to be received and viewed on the display panel, and to also be stored for later viewing.

It is another object of the present invention to provide an electronic magazine which is particularly adapted for use by virtually any number of readers such as in a doctor's or dentist's office or business office, where each reader may select virtually any periodical for downloading and viewing and different periodicals may be viewed in sequence by different viewers of the electronic magazine.

This invention contemplates a method for providing a subscription service for periodical publications to a subscriber by an authorizing authority, the method comprising the steps of assigning to a subscriber a personal authorization code; verifying that the subscriber has an assigned personal authorization code; offering a subscription to one or more periodical publications at a remote terminal of an authorized subscriber via a global information network; receiving periodical publication subscription selections entered by the authorized subscriber at the remote terminal via the global information network; providing requested periodical publications in real time via the global information network to the remote terminal of the authorized subscriber in accordance with the periodical publication subscription selections; and downloading the requested periodical publications to the remote terminal for viewing by the authorized subscriber.

### BRIEF DESCRIPTION OF THE DRAWINGS

The appended claims set forth those novel features which characterize the invention. However, the invention itself, as well as further objects and advantages thereof, will best be understood by reference to the following detailed description of a preferred embodiment taken in conjunction with the accompanying drawings, where like reference characters identify like elements throughout the various figures, in which:

FIG. 1 is a simplified block diagram of an e-commerce periodical subscription system in accordance with the principles of the present invention;

FIGS. 2a-2e are simplified flow charts illustrating the series of steps carried out under computer control in an e-commerce periodical subscription service in accordance with the present invention;

FIG. 3 is a simplified block diagram illustrating the various selection options available to a user of the periodical subscription service of the present invention by means of a remote terminal;

FIG. 4 is a simplified elevation view of an integrated video display and control panel for use in a subscriber remote terminal in accordance with one aspect of the present invention; and

FIG. 5 is a simplified flow chart illustrating the series of steps involved in the verification of an authorizing code assigned to an individual subscriber and/or the subscriber's receiving device, or remote terminal.

### DETAILED DESCRIPTION OF THE PREFERRED EMBODIMENTS

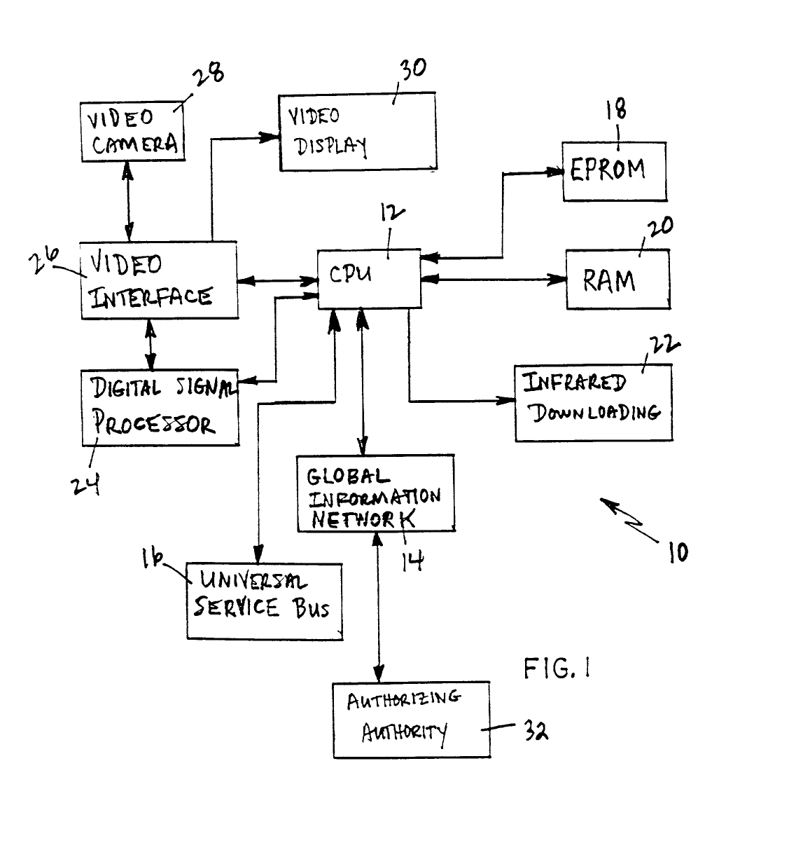

Referring to FIG. 1, there is shown a simplified block diagram of an e-commerce periodical subscription system 10 in accordance with the principles of the present invention. Periodical subscription system 10 includes a central processor unit (CPU) 12 coupled to a global information network 14. It is by means of the global information network 14 that the CPU 12 is connected to and interfaces with an authorizing authority 32 which administers the subscription service and distributes the periodicals for downloading. The global information network 14 may be in the form of the Internet, the Ethernet or other wide area communications network such as, for example, one using satellites, wireless or cellular links, or cable/DSL links. Periodical subscription system 10 further includes a random access memory (RAM), or other storage means, 20 for storing information and operating instructions to be executed by CPU 12. Periodical subscription system 10 also includes an erasable programable read only memory (EPROM) 18, or other static storage device, for storing static information and operating instructions for CPU 12. Also coupled to CPU 12 is a universal service bus 16, as well as an infrared downloading arrangement 22 for downloading, by means of CPU 12, a periodical publication stored in RAM 20. CPU 12 may also incorporate a computer program for translating non-English language publications into English. Also connected to CPU 12 is a digital signal processor 24 and a video interface circuit 26 . Video interface circuit 26 is coupled to a video camera 28 as well as to a video display 30. Video interface circuit 26 drives video display 30 in presenting the contents of a periodical publication stored in RAM 20. Video interface circuit 26 also allows for face-to-face communication by means of video camera 28 between a subscriber and the authorizing authority 32 providing the subscription service. Video display 30 is preferably of the flat panel type and may be in the form of a plasma display, a light emitting diode (LED) display, a liquid crystal diode (LCD) display, or virtually any type of video display. For example, video display 30 may also include a touch screen capability to permit the subscriber to enter information via the screen. Video display 30 may also be a conventional cathode ray tube (CRT) as available in most personal computer (PC) terminals. The size of EPROM 18 is preferably at least two mega bytes, while the size of the RAM 20 is preferably at least 16 mega bytes. Video interface circuit 26 includes a random access memory preferably having a capacity of at least two mega bytes.

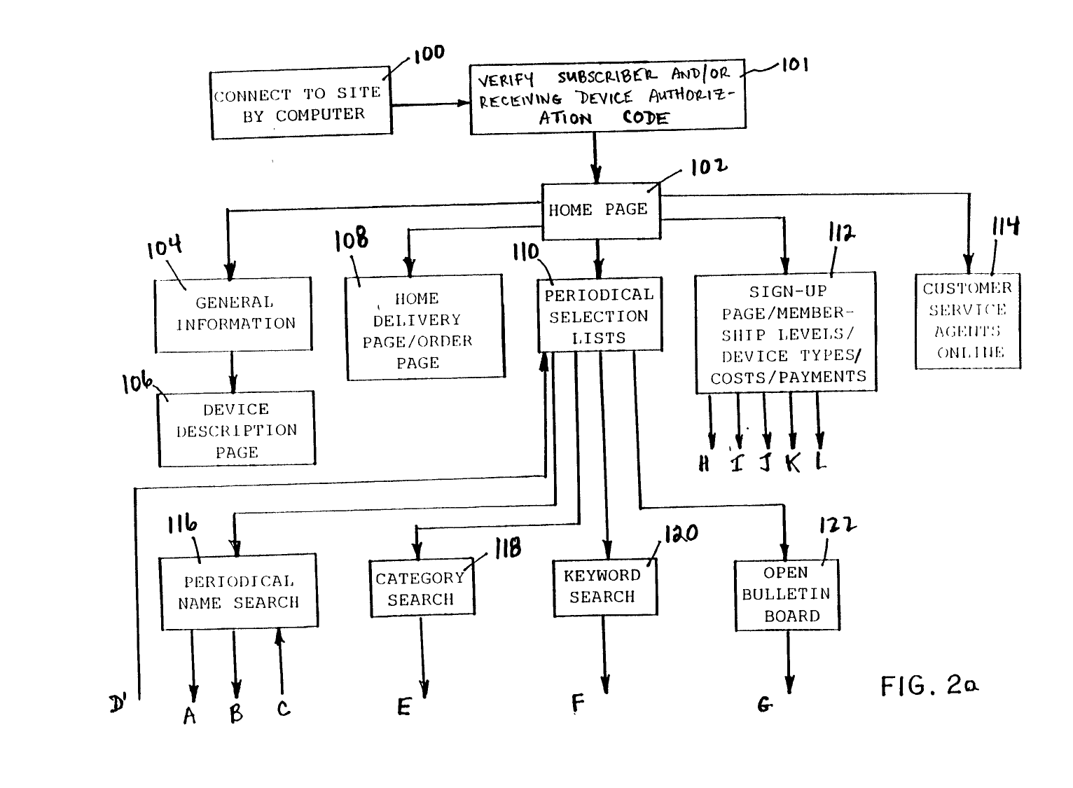

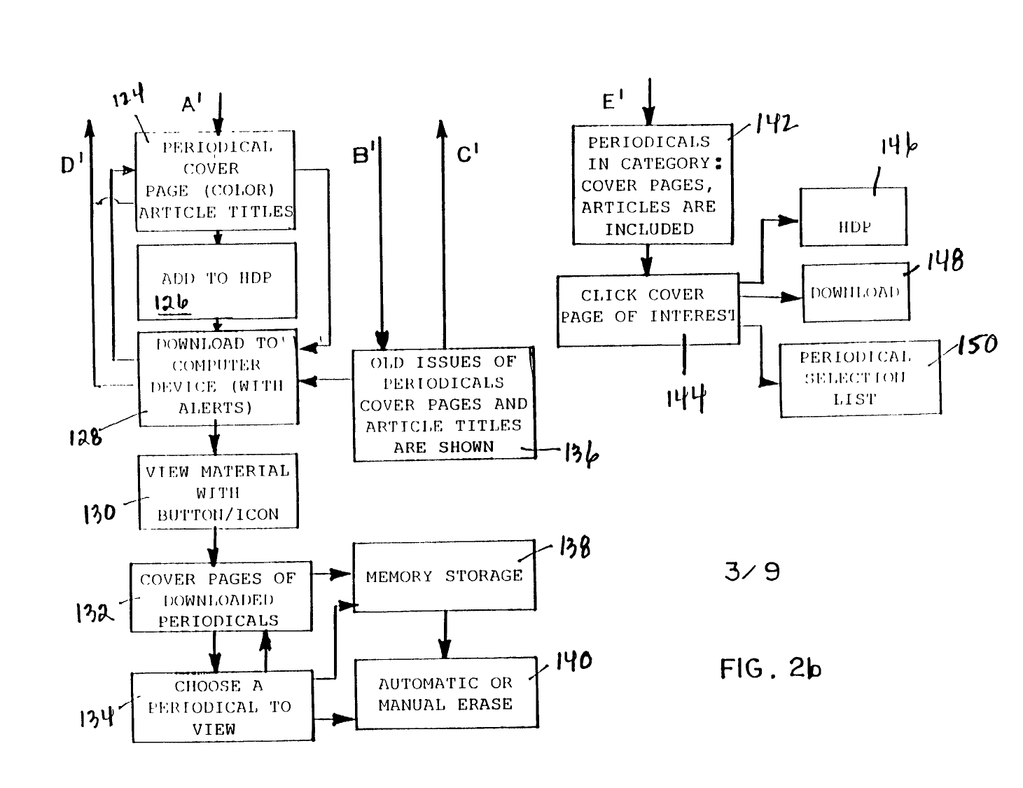

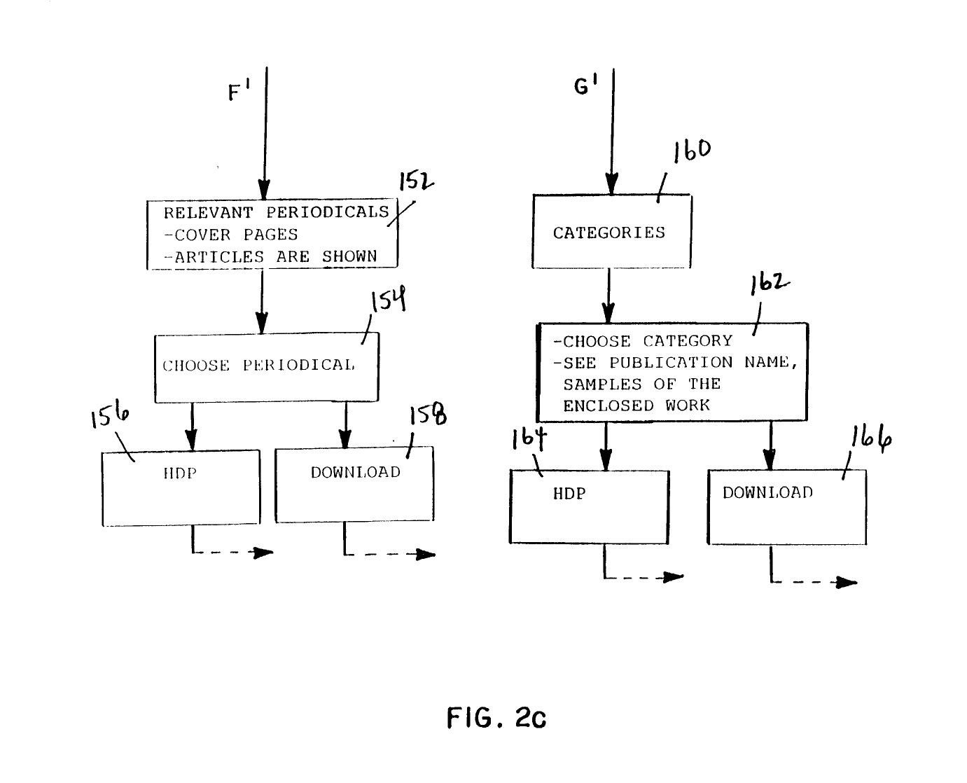

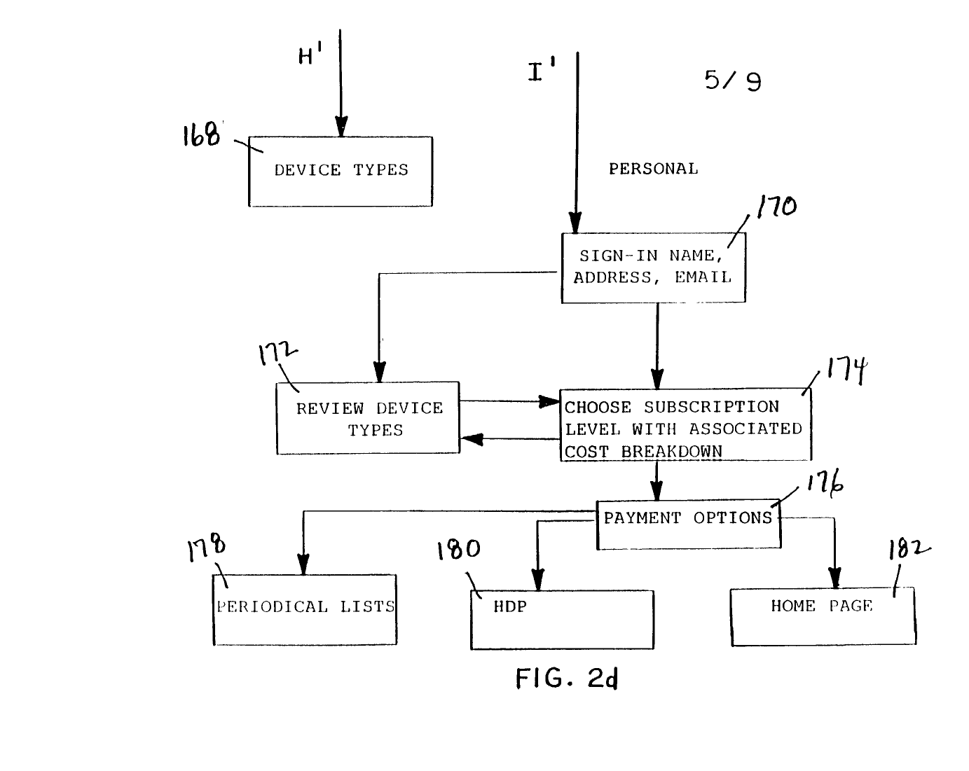

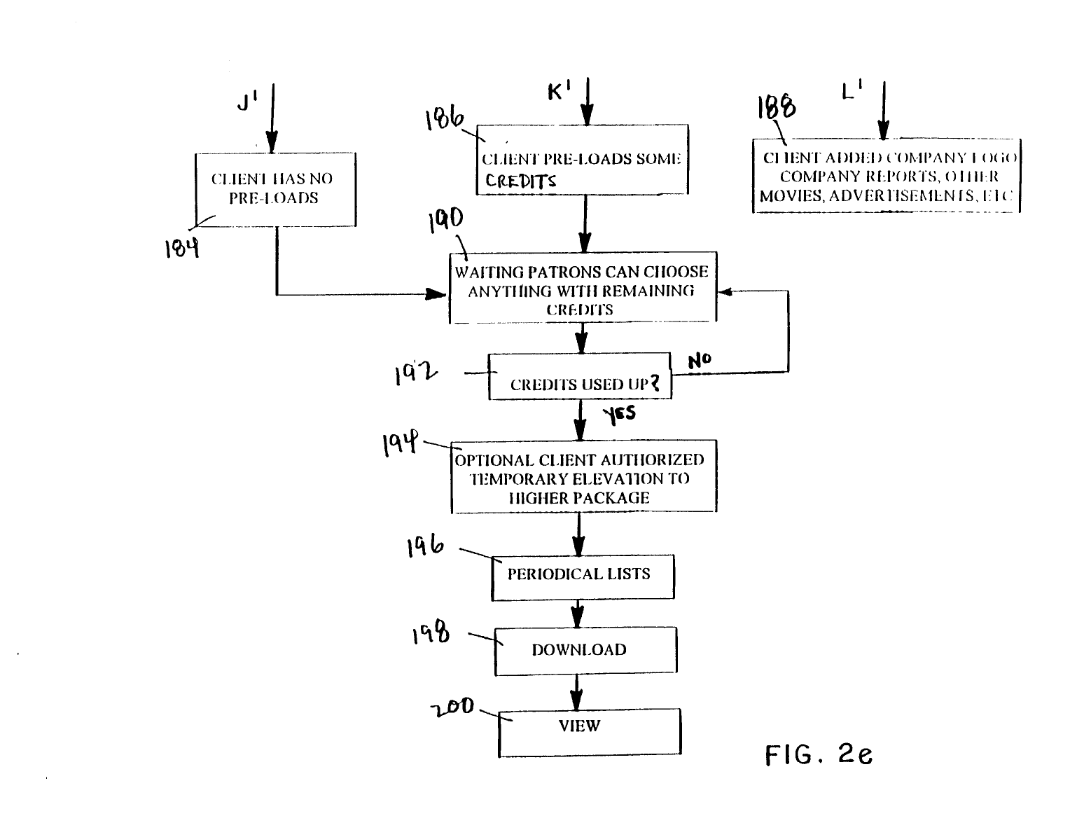

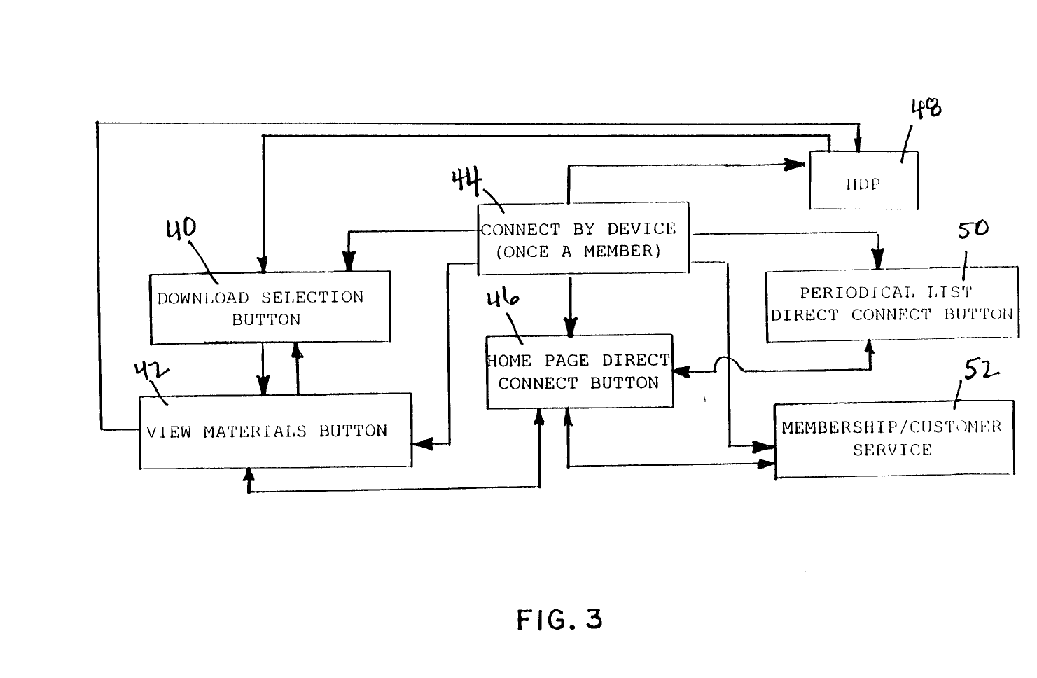

Referring to FIG. 2a-2e there are shown a series of flow charts illustrating the steps carried out either automatically under the control of CPU 12 or manually by a subscriber in ordering periodical subscriptions and receiving copies of the requested periodicals. The various flow charts shown in FIGS. 2a-2e are connected together by lines designated by primed and unprimed letters. Thus, line designated A in FIG. 2a is continued in FIG. 2b as line A′. Some of the operations shown in the flow charts of FIG. 2a-2e are accomplished automatically by means of CPU 12 in accordance with instructions and data stored in EPROM 18 and RAM 20. Other operations are selected by the subscriber using various selector buttons and input instructions provided by the subscriber. These selector buttons and input instructions are shown in simplified block diagram form in FIG. 3 and will be referred to in describing the sequence of steps set forth in FIG. 2a-2e undertaken in carrying out the e-commerce periodical subscription method of the present invention. The selector buttons shown in FIG. 3 may be in the form of designated keys or combinations of selected keys on a keyboard in a subscriber terminal described in detail below.

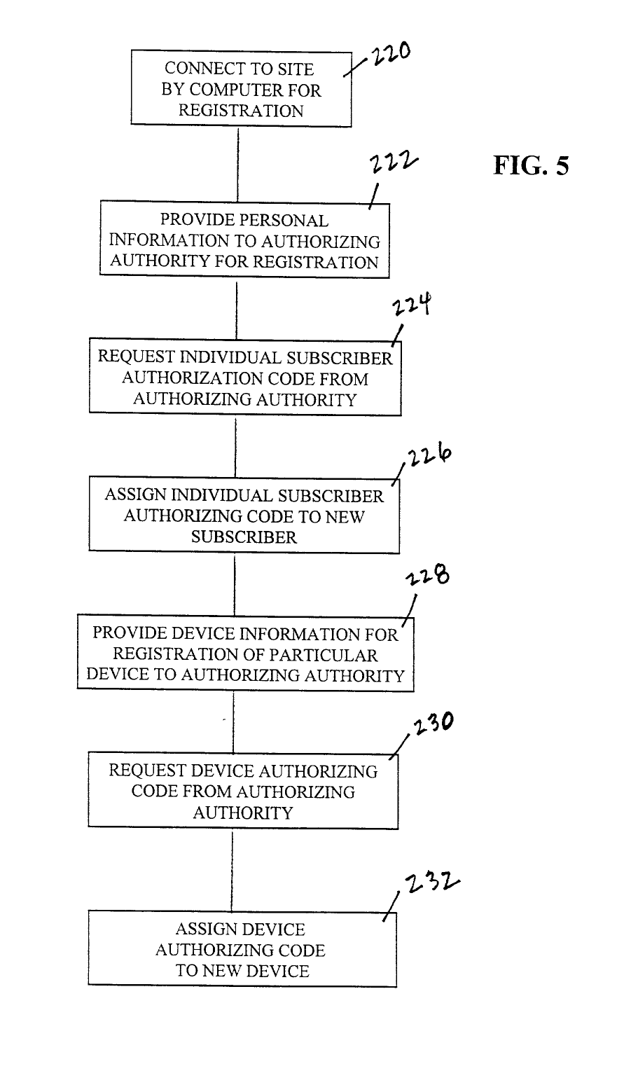

As shown in FIG. 2a, the operating program stored in CPU 12 is initiated at step 100 when the subscriber's terminal is connected to the authorizing authority 32 by means of the global information network 14. It should be noted here that the connection of the subscriber's terminal to the global information network 14 may be either by a conventional wired telephone line, a cellular telephone network, a wireless link, a DSL or cable link, a satellite link, or any other communications link. After connection of the subscriber's terminal to the authorizing authority 32 at step 100, the operating program under the control of CPU 12 then proceeds to the home page of the authorizing authority at step 102 after verifying the subscriber and/or receiving device authorization code at step 101. Details of the manner in which the individual subscriber and/or specified receiving device authorization code is verified are described below in terms of FIG. 5. After accessing the authority's home page at step 102, the subscriber then has the option of selecting various options by means of the subscriber's terminal. These options include the selection of general information at step 104, followed by a device description page at step 106. The device description page provides the subscriber with information as to the operation and capabilities of the subscriber's terminal. The subscriber also has the option of accessing the home delivery/order page of the authorizing authority at step 108. The authorizing authority's home delivery/order page allows the subscriber to place an order for one or more periodicals or to change an existing order from one periodical to another periodical. Orders may also be entered for future editions to a selected periodical, where the subscription is initiated on a selected date in the future. Orders may also be entered for past editions for downloading. Subscriber orders are preferably entered and changed by means of an interactive procedure with the subscriber using prompts and information entered by the subscriber as described below.

The subscriber may also proceed from the authorizing authority's home page to periodical selection lists at step 110. The subscriber then may either conduct a periodical name search at step 116, a category or subject matter search at step 118, a keyword search at step 120, or the subscriber may access an open bulletin board in step 122. If the subscriber elects a periodical name search at step 116, the program proceeds as shown in FIG. 2b to step 124 for presenting the periodical cover page and article titles of a selected periodical. The selected periodical cover page and article titles may be entered on the subscriber's home delivery page (HDP) at step 126 for the purpose of ordering the subscription to one or more periodicals. The program then downloads the requested periodical at step 128 to the subscriber's terminal. The subscriber can then elect to return to the periodical selection list at step 110 and conduct additional periodical name searches, or the subscriber can proceed to step 130 for viewing the downloaded material with the view materials button 42 shown in FIG. 3. The cover pages of the downloaded periodicals are presented on the subscriber's video display at step 132 and are stored in memory at step 138. The subscriber may also choose a periodical to view at step 134 which also may stored in memory at step 138. The contents of the memory may be either automatically, such as after a designated time period, or manually erased from memory at step 140. The subscriber's HDP may also be used for displaying the subscription history of the subscriber.

In initiating a periodical name search at step 116, the subscriber may also elect to proceed to step 136 for downloading the cover pages and article titles of old issues of periodicals at step 128. These cover pages and article titles of old periodicals may then be viewed and stored in memory at steps 130-138 as previously described. The describer may repeat this search of periodical cover pages and article titles by returning to the periodical name search initiation step 116.

If at step 110 the subscriber elects to conduct a category or subject matter search, the program proceeds to step 118 and searches the cover pages and articles of old issues of periodicals dealing with the selected category at step 142. By clicking the mouse control, the subscriber at step 144 may elect various options for processing the periodical category information uncovered during this search. For example, the subscriber may at step 146 elect to store the periodical category search information in the subscriber's Home Delivery Page (HDP). A subscriber may also elect at step 148 to download the periodical category search information for viewing. Finally, a subscriber at step 150 may elect to display all of the periodicals available on the periodical selection list. If the subscriber at step 110 in accessing the periodical selection list elects to conduct a keyword search at step 120, the program proceeds to step 120 and initiates a search in accordance with a keyword, or keywords, entered by the subscriber. At stepl52 the program collects the cover page and articles in all relevant periodicals associated with the keyword, or keywords, selected by the subscriber and presents this information on the subscriber's display screen. The program then allows the subscriber to chose one or more periodicals at step 154. The selected periodicals are then presented on the subscriber's Home Delivery Page at step 156 and may be downloaded at step 158.

If the subscriber accesses the periodical selection list at step 110 and elects to open a bulletin board at step 122, the program proceeds to step 160 and lists the various categories available for searching the available periodicals. The subscriber next at step 162 chooses a desired category to search, and the program then displays the name of a publication as well as samples of articles in that publication which are relevant to the requested category. The reviewed publication materials may then be either displayed on a Home Delivery Page (HDP) at step 164 or downloaded at step 166. The bulletin board may also be used to store other documents which may be searched and downloaded by subscribers.

If after accessing the authorizing authority's home page at step 102, the viewer desires to initiate an order for a periodical or periodicals or to change an order, the viewer elects the sign-up page membership levels/device types/cost/payment option at step 112. The viewer is then given the option of selecting the type of device to be used for viewing periodicals at step 168. The viewer is further given the option of entering his or her own name, address and e-mail address at step 170. The viewer may then either review the types of devices available for viewing publications at step 172 or choose a particular subscription level having an associated cost break down at step 174. The present invention contemplates having a range of membership levels each having an associated number of subscriptions to individual periodicals. Thus, a viewer may sign up for a first subscription level involving one periodical, a second subscription level involving two periodicals, etc. The subscriber may then change subscriptions to that periodical (or to two periodicals in the case of the second subscription level), as desired. The subscriber is then given the opportunity at step 176 to select various payment options, i.e., check, credit card, debit card, etc. and then to select specific periodicals at step 178, depending upon the elected subscription level. The subscriber is further given the opportunity to select either the subscriber's authorizing authority's home delivery page (HDP) at step 180 or the home page at step 182. The subscriber's HDP will list the periodical selections made by the subscriber, while the authorizing authority's home page would list the periodicals available for selection by the subscriber.

After step 112, the subscriber may elect to proceed to step 184 and, if the subscriber does not desire to pre-load, or purchase, some subscription credits, thence to step 190. At step 190, the subscriber may choose any available periodical using any remaining credits in his or her account. At step 112, the subscriber may also elect to proceed to step 186 for purchasing additional subscription credits, or preloads. The program then proceeds to step 190 allowing the subscriber to choose any available periodicals with his or her remaining credits, or preloads. At step 192, the program determines if the subscriber has any available credits. If the subscriber has available credits, the program returns to step 190, permitting the subscriber to choose additional periodicals until his or her credits are used up. Once the subscriber's credits are used up or the subscriber no longer desires to select any additional periodicals, the program proceeds to step 194 and permits the subscriber to select a temporary increase, or elevation, to his or her subscriber package. The subscriber may temporarily elevate his or her subscription level such as for a month, quarter, six months, a year, etc., to obtain additional periodicals for a limited time. Once the preselected period expires, the subscriber's subscription level automatically returns to the original level for the next billing period. The program then proceeds to step 196 for providing the subscriber with periodical lists to review and select from. The selected periodicals are then downloaded at step 198 for viewing by the subscriber at step 200.

At step 112 the subscriber may also elect to proceed to step 188, allowing the subscriber to add a company logo, company report, or other marketing tool such as a video or advertisement to the presentation on the subscriber terminal's video display prior to viewing requested periodicals. This latter approach may be particularly useful where the subscriber terminal is used in a waiting room such as a dentist or doctor's office or at corporate offices.

Referring to FIG. 5, there is shown a simplified flow chart illustrating the series of steps involved in the verification of an authorizing code assigned to an individual subscriber and/or to the subscriber's receiving device, or remote terminal. Following connection of the subscriber's terminal to the authorizing authority by means of the global information network at step 100 as shown in FIG. 2a, the operating program under the control of CPU 12 then performs a series of operations for verifying the subscriber and/or receiving device authorization code at step 101 also as shown in FIG. 2a. FIG. 5 shows the detailed series of steps involved in verifying a subscriber and/or receiving device authorization code. At step 220, the subscriber is connected to the authorizing authority by computer for registration. At step 222, a subscriber provides personal information to the authorizing authority. At step 224, the subscriber requests an individual subscriber authorization code from the authorizing authority. The authorizing authority then at step 226 assigns an individual subscriber authorization code to the new subscriber. The new subscriber then may provide device information for registration of a particular receiving device to the authorizing authority at step 228. The subscriber then requests a device authorization code from the authorizing authority at step 230 for authorizing a particular device for use by the subscriber. The authorizing authority at step 232 then assigns a device authorization code to the particular device for which the subscriber has requested in authorization code. Steps 228, 230 and 232 are optional and may be used to prevent unauthorized receipt/use of the subscription materials while allowing for increased flexibility in delivering the materials to an authorized subscriber. For example, the use of only an individual subscriber authorization code permits the subscriber to use virtually any receiving device for receipt of the subscription materials provided the subscriber has a valid individual authorization code. Providing an authorization code to both the individual subscriber and a designated terminal provides increased security for the materials distributed via the periodical subscription service in that the subscriber must enter his or her authorization code on the designated receiving device, the authorization code of which must also be verified before a requested periodical can be viewed. This increased security feature provides added protection for the loss or theft of an individual subscriber's authorization code and its use by another. In addition, by assigning a code to the individual subscriber as well as to one or more designated terminals, an authorized subscriber can use any one of the designated terminals to receive a requested periodical.

Referring to FIG. 3, there is shown a simplified block diagram of various selector buttons and switches available to the subscriber. A download selection button 40 allows the subscriber to download periodicals from the authorizing authority to the subscriber's terminal. A view materials button 42 allows the subscriber to scan through periodicals which are available and to also review the contents of the available periodicals without downloading. The home page direct connect button 46 allows the subscriber to connect directly to the home page of the authorizing authority. A membership/customer service selector 52 allows the subscriber to directly access the authorizing authority providing the requested periodicals. The periodical list direct connect button 50 allows the subscriber to directly review available periodical lists. The device selector 44 on the subscriber's terminal activates the terminal for accessing publication information from the authorizing authority. As indicated above, the buttons and selectors shown in FIG. 3 may be in the form of individual selector buttons, a soft selector button which can be assigned various selector functions by the subscriber, or a conventional keyboard where selected keys, or combinations of keys, are each assigned a specific function.

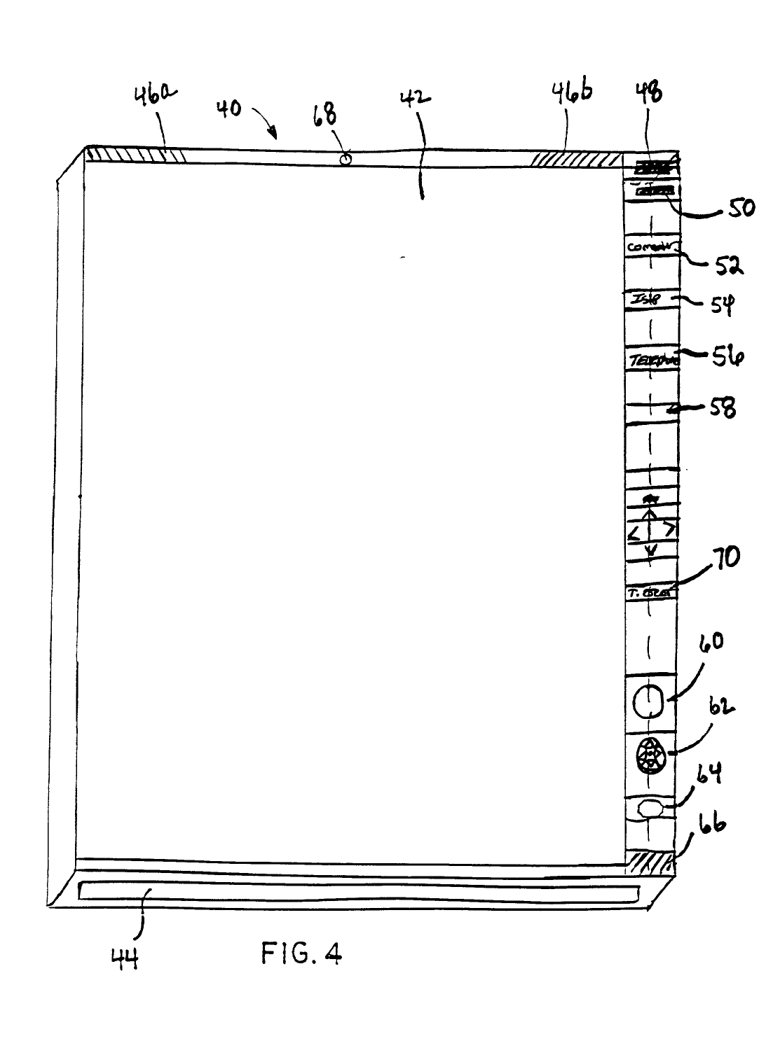

Referring to FIG. 4, there is shown a perspective view of one embodiment of a subscriber terminal 40 for use in the present invention. Subscriber terminal 40 includes the various components shown in FIG. 1 (which are not shown in FIG. 4 for simplicity) and is adapted for connection to the authorizing authority by means of the global information network. Subscriber terminal 40 in the embodiment shown includes a flat panel display screen 42 on which ordered publications are viewed. Subscriber requests and information entered by means of a pop-out keyboard 44 in the subscriber terminal 40 may also be presented on the display screen 42. In another embodiment, display screen 42 may be divided into an upper section and a lower section, where the upper section is used to view periodicals and the lower section of the display screen includes a keyboard to permit the subscriber to input information and commands using touch screen technology. Subscriber terminal 40 further includes first and second audio speakers 46a and 46b for communication with the authorizing authority. Subscriber terminal 40 also includes a video camera 68 to permit video telephone communications between the subscriber and the authorizing authority. In this connection, a telephone selector 56 and a telephone line connector, or jack, 70 are provided in the subscriber terminal 40. The subscriber terminal 40 may include an internal modem or it may be connected to an external modem and is adapted for use with DSL cable, wireless and cellular networks, and satellite communications systems. Also included in the subscriber terminal 40 is an ON/OFF switch 48, as well as an automatic download selector 50. The automatic download selector 50 allows the subscriber terminal 40 to automatically download periodicals provided by the authorizing authority. Subscriber terminal 44 further includes a facsimile selector 52 for faxing subscription requests and an Internet Protocol (IP) selector 54 for communicating via the Internet. A keyboard selector 58 causes the pop-out keyboard 44 to extend from the subscriber terminal 40 for use by the subscriber. A mouse control 60 as well as a page selector 64 are also incorporated in the subscriber terminal 40. Page selector 64 permits a subscriber to scan through a periodical presented on the display screen 42 in a page-by-page manner or to access any page or pages in virtually any order. A manual download selector 62 permits a subscriber to manually download selected pages of a viewed periodical. A built-in microphone 66 in the subscriber terminal 40 allows a subscriber to communicate by telephone or Internet voice mode to the authorizing authority. Finally, subscriber terminal 40 may include a rechargeable battery (not shown for simplicity) as well as a recharging unit 72 adapted to receive the subscriber terminal for recharging its battery. Providing the subscriber terminal 40 with a rechargeable battery would provide it with portability, allowing a reader to use the terminal as a magazine in carrying the terminal and using it virtually anywhere.

While particular embodiments of the present invention have been shown and described, it will be obvious to those skilled in the relevant art that changes and modifications may be made without the parting from the invention in its broader aspects. Therefore, the aim in the appended claims is to cover all such changes and modifications as fall within the true spirit and scope of the invention. The matter set forth in the foregoing description in accompanying drawings is offered by way of illustration only and not as a limitation. The actual scope of the invention is intended to be defined in the following claims when viewed in their proper perspective based on the prior art.

I claim:

1. A method for providing a multi-issue or single issue subscription service for periodical publications to a subscriber by an authorizing authority, said method comprising the steps of:
assigning to a subscriber a personal authorization code;
verifying that the subscriber has an assigned personal authorization code;
offering a subscription to one or more periodical publications at a remote terminal of an authorized subscriber via a communications network, wherein said subscription includes at least one edition of a periodical publication;
receiving periodical publication subscription selections entered by the authorized subscriber at said remote terminal via said communications network;
providing requested periodical publications in real time via said communications network to said remote terminal of the authorized subscriber in accordance with said periodical publication subscription selections; and
downloading the requested periodical publications to said remote terminal for viewing by the authorized subscriber.

2. The method of claim 1 further comprising the steps of assigning a device authorization code to a remote terminal designated by an authorized subscriber and verifying the device authorization code for a designated remote terminal prior to downloading the requested periodical publications to said designated remote terminal for viewing by the authorized subscriber.

3. The method of claim 1 further comprising the step of entering the subscriber's personal authorization code on said remote terminal in providing the subscriber's personal authorization code to the authorizing authority.

4. The method of claim 1 further comprising the step of receiving payment from the subscriber via said communications network for the requested periodical applications and crediting said payment to a subscription account of the subscriber.

5. The method of claim 4 further comprising the step of debiting or charging said subscription account for payment for periodical publication subscription selections entered by the subscriber and providing a current balance of the subscription account to said remote terminal for viewing by the subscriber following each entry of a subscription selection.

6. The method of claim 5 further comprising the step of periodically providing the current balance of the subscription account to said remote terminal for viewing by the subscriber.

7. The method of claim 1 further comprising the step of providing a listing of available periodical publications to said remote terminal via said communications network for review and selection by the subscriber.

8. The method of claim 7 further comprising the step of providing a search capability for the subscriber whereby the subscriber can search said listing of available periodical publications by subject matter category.

9. The method of claim 7 further comprising the step of providing a search capability for the subscriber whereby the subscriber can search said listing of available periodical publications by name, classification or keywords.

10. The method of claim 1 further comprising the step of storing requested periodical publications downloaded to said remote terminal in a memory for subsequent viewing by the subscriber.

11. The method of claim 1 further comprising the step of streaming requested publications to said remote terminal for viewing by the subscriber.

12. The method of claim 1 wherein the requested periodical publications are automatically downloaded to said remote terminal upon receipt of periodical publication subscription selections entered by the subscriber.

13. The method of claim 1 further comprising the step of entering of a download input by the subscriber for downloading requested periodical publications to said remote terminal.

14. The method of claim 1 further comprising the step of offering plural types of remote terminals to the subscriber and allowing the subscriber to select one of said plural types of remote terminals.

15. The method of claim 14 further comprising the step of allowing the subscriber to review the plural types of available remote terminals prior to the subscriber selecting one of the remote terminals.

16. The method of claim 1 further comprising the step of offering plural subscription service levels to a subscriber, wherein a first subscription level includes X periodical publications and a second subscription level includes Y publications, where X>Y.

17. The method of claim 16 further comprising the step of allowing the subscriber to change between said first and second subscription levels for a designated time.

18. The method of claim 17 further comprising the step of resuming said first subscription level following a change to said second subscription level after said designated time.

19. The method of claim 1 further comprising the step of translating a non-English language publication into English for viewing by the subscriber on said remote terminal.

20. The method of claim 1 wherein said at least one edition of a periodical publication is a back issue.

21. The method of claim 1 further comprising the step of the subscriber selecting a future date for initiation of a subscription to a requested periodical publication.

22. The method of claim 1 further comprising the step of selecting a future date for initiation or termination of a subscription to a requested publication.
